(19) United States
(12) Patent Application Publication
(10) Pub. No.: US 2009/0266295 A1
(43) Pub. Date: Oct. 29, 2009

(54) TILING ADHESIVE APPLICATOR

(76) Inventor: Stuart Edward Saunders, Great Yarmouth Norfolk (GB)

Correspondence Address: BROOKS KUSHMAN P.C., 1000 TOWN CENTER, TWENTY-SECOND FLOOR, SOUTHFIELD, MI, 48075, US

(21) Appl. No.: 11/913,561

(22) PCT Filed: May 8, 2006
(86) PCT No.: PCT/GB06/50094

§ 371 Date: Nov. 5, 2007

(30) Foreign Application Priority Data
May 6, 2005 (GB) 0509183.0
Jul. 20, 2005 (GB) 0514835.8
Aug. 17, 2005 (GB) 0516844.8

(51) Int. Cl. B05B 9/04

(52) U.S. Cl. 118/300

(57) ABSTRACT

Apparatus (10) for applying adhesive to a surface to be tiled has a container (11) for the adhesive and a pair of opposed end walls (12,14) at least one of which is removable. The container has an outlet port (24) and one end wall (14) supports a plunger (19,23) for driving adhesive through the port (24) out of the container A drive mechanism such as a hydraulic ram (17) is provided on that one end wall (14) to cause movement of the plunger (19,23). A multi-outlet nozzle (26) for adhesive is connected by a duct (25) to the outlet port so that a plurality of beads of the adhesive are laid on the surface to be tiled.

This invention relates to apparatus for applying adhesive to a surface to be tiled. In its preferred aspect, the apparatus is arranged to apply several parallel beads of adhesive from an applicator, simultaneously to the surface.

The conventional procedure for tiling a surface is to have a large tub of the adhesive and then to scoop the adhesive out of the tub and apply it to the surface with a spatula or similar item. The adhesive is spread out on the surface and then with a toothed implement individual beads are formed in the applied adhesive. This is both a time consuming and inefficient procedure, often leading to irregular beads of various thicknesses, together with significant waste which may fall to the floor when a vertical surface is to be tiled.

Adhesive applicators have been proposed where adhesive is supplied under pressure to a nozzle forming a part of a hand-held implement, whereby a bead of adhesive may directly be applied to the surface. Generally, however, such applicators are relatively slow to operate and if a large area is to be tiled, they are not very practical.

This invention aims at providing apparatus which is capable of applying adhesive over a large surface such as a wall or floor, in readiness for the laying of tiles and without the need to perform any further preparation work once the beads of adhesive have been deposited on the surface.

Thus, according to this invention there is provided apparatus for applying adhesive to a surface to be tiled and having a container for the adhesive, an applicator having at least one outlet opening for adhesive and a duct interconnecting the applicator with an adhesive outlet port provided on the container, wherein the container is of generally tubular form having opposed end walls at least one of which is in the form of a removable lid for the container, a plunger supported on one of the end walls for movement into the container so as to expel adhesive from the container, and a drive arrangement operable to cause relative movement of the plunger with respect to the end wall supporting the plunger thereby to expel adhesive from the container through the duct to the applicator.

In a preferred embodiment, the applicator has a plurality of nozzles arranged in a line so that a plurality of beads of adhesive are extruded out of the applicator simultaneously on operation of the drive arrangement. In this way, it becomes possible to lay a plurality of beads of adhesive on the surface to be tiled, without any other step being required following that, before the tiles are laid on the surface. By having a container of the adhesive and a drive arrangement which permits continuous extrusion of the beads of adhesive out of the applicator, down time for example for recharging the apparatus is much reduced. In this way, it becomes possible to perform tiling in a rapid and efficient manner.

The apparatus of this invention may be in either one of two generic forms; the drive arrangement may employ a hydraulic or pneumatic ram, or may be essentially mechanical with either an electric motor acting as the power source or with a handle arrangement so permitting manual operation. Particularly in the case of a hydraulic or pneumatic ram or when an electric motor is provided, it is advantageous for there to be a manual override to permit operation even in the event that there is no electricity supply available, or if rechargeable batteries are used, those batteries are run down.

In a hydraulic or pneumatic system, there may be a ram including a cylinder and piston combination with a ram-rod connected to the piston and projecting from the cylinder. In this case, the cylinder is preferably mounted on the end wall supporting the plunger so that the ram-rod may itself serve as the plunger, that ram-rod being indirectly mounted on the end wall, through the cylinder. The ram may be mounted externally on the end wall with the ram-rod projecting through an opening in the end wall into the container, or the ram may be mounted internally within the container, again on the end wall. Either way, the free end of the ram-rod may carry a piston co-operable with the container so that adhesive within the container will be expelled out of the outlet port provided in the container on expansion of the ram to move the piston further into the container.

In the case of a hydraulic ram, operation thereof may be performed by a manual hydraulic pump mounted on the container or on the end wall supporting the ram and including a lever projecting from the pump to permit manual operation thereof. The hydraulic reservoir may be integrated with the ram cylinder and in a preferred embodiment, a conventional hydraulic bottle-jack is employed as the hydraulic ram. Such a bottle-jack could be of a known inverted form, where the ram-rod projects downwardly from the cylinder, rather than the more usual arrangement where the ram-rod projects upwardly from the cylinder.

In one embodiment, the ram-rod supports a chamber for adhesive which chamber is disposed slidably within the container and the container has a pressure member slidably received within the chamber. Movement of the chamber on expansion of the ram causes adhesive contained within the chamber to be expelled therefrom. Conveniently, the pressure member includes a hollow support rod secured to the container and serving as the outlet port from the container, and a piston mounted on one end of that rod which piston is slidably received in the chamber, whereby the adhesive is expelled out of the hollow support rod from where it is directed to the duct leading away from the container.

In the mechanical version, the container preferably has a cylindrical portion and there is a piston slidably and sealingly received in that cylindrical portion. The piston is carried on the plunger which extends through an opening in the end wall of the container and supporting the plunger. In one embodiment, the plunger has a toothed rack formed therealong, which rack is driven by a pinion mounted on the output shaft of an electric motor and gearbox combination, or by a pinion linked through a suitable mechanism to a manually-operable handle. In another embodiment, the plunger is screw-threaded and is engaged with a threaded bore either in the end wall supporting the plunger, or in a separate internally screw-threaded rotatable member mounted on said end wall. A drive arrangement is provided to rotate the plunger or the rotatable member, thereby to cause the plunger to rise and fall as required, with respect to the container.

The drive arrangement may comprise and electric motor and gearbox combination carrying a worm on its output shaft, which worm is meshed with a toothed wheel carried on the plunger and connected thereto to effect rotation of the plunger, but with the wheel free to slide axially along the length of the plunger. The toothed wheel is restrained against axial movement so that on operation of the motor to cause rotation of the wheel, the plunger is threaded upwardly or downwardly with respect to the container. For this arrangement, a crank handle may be provided on the upper end of the plunger whereby the plunger may be screwed upwardly or downwardly without operation of the motor, though in view of the worm drive, it may be necessary to disconnect the worm from the toothed wheel.

An alternative arrangement is to have the plunger restrained against rotation with respect to the end wall, though free to slide axially through that end wall, and to have a rotatable member threadingly engaged with the plunger, whereby rotation of that member will cause the plunger to rise or fall.

The drive arrangement may be mounted on the end wall of the container which is in the form of a removable lid, or may be mounted on the opposed end wall, which may be an integral part of the container. In the alternative, both end walls of the container may be removable. In this case, the end wall supporting the drive arrangement may be removable for example for servicing of the drive arrangement and the other end wall may be removable for loading the container with adhesive.

Instead of filling adhesive directly into the container, it would be possible to have the adhesive within a secondary container, such as a flexible container or a rigid tube. In the case of a flexible carrier, this may take the form of a tube formed from a flexible material which tube may be opened and then secured to an outlet from the container, so that on subsequent movement of the piston into the container the tube is squeezed and so adhesive is expelled. The tube could be a close fit within the container, in which case it may not be necessary to secure the opened tube to an outlet from the container.

In the case of a rigid tube of adhesive, this may have a piston enclosing adhesive pre-loaded into the tube and an end wall provided with a threaded nipple to permit the tube to be connected to an outlet provided in the end wall of the container, at the end thereof opposed to the end wall. The nipple is opened, for example by cutting off the end of the nipple, whereafter the container is screwed into the outlet in the container end wall. The plunger may then be moved to engage the piston of the tube, and further driving of the mechanism expels adhesive out of the tube, through the nipple and into the duct.

A preferred form of the apparatus has an applicator in the form of a hand-held device having a plurality of outlet ports for adhesive. Such an application may be connected to the outlet port of the container by means of a flexible hose. Alternatively, the container may be provided with wheels to permit it to be rolled over a floor to be tiled and in this case the applicator may connect directly to the container through an essentially rigid duct.

Preferably, the adhesive applicator is readily disassembled to permit cleaning when required. The applicator may include a control valve to permit the control of the outflow of adhesive from the applicator. Further, it may include one or more switches to allow control of the drive arrangement for the container and plunger combination. In addition, a safety cut-out arrangement may be provided whereby the power supplied to the electric motor of an electrically powered embodiment is inhibited in the event that the current draw exceeds a pre-set value.

By way of example only, five embodiments of a tiling adhesive application apparatus constructed and arranged in accordance with the present invention and certain modifications thereof will now be described in detail, reference being made to the accompanying drawings in which:

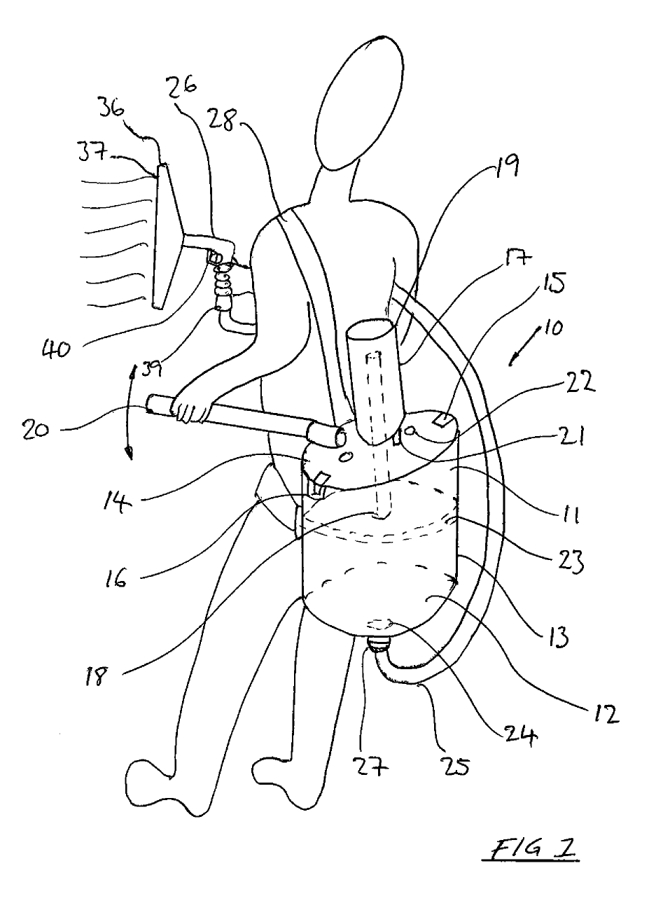

FIG. 1 is an illustration of a first embodiment of this invention incorporating an inverted bottle jack;

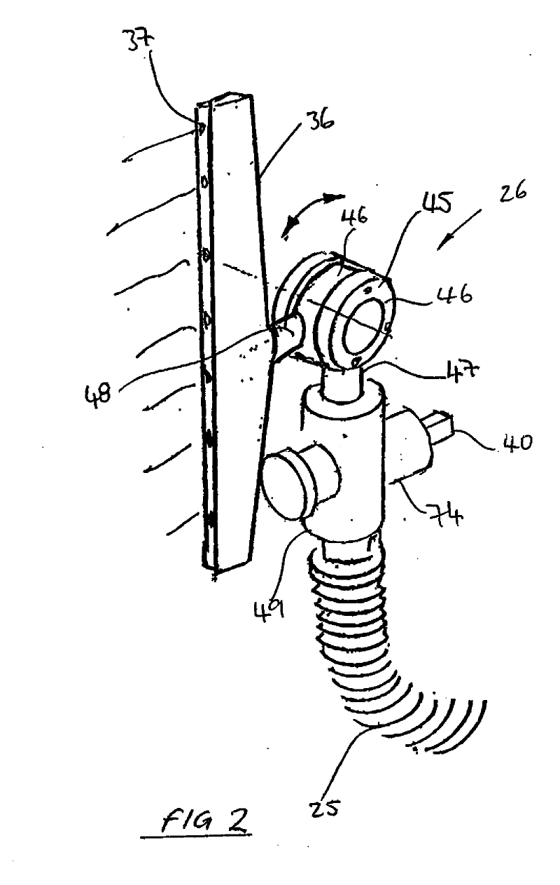

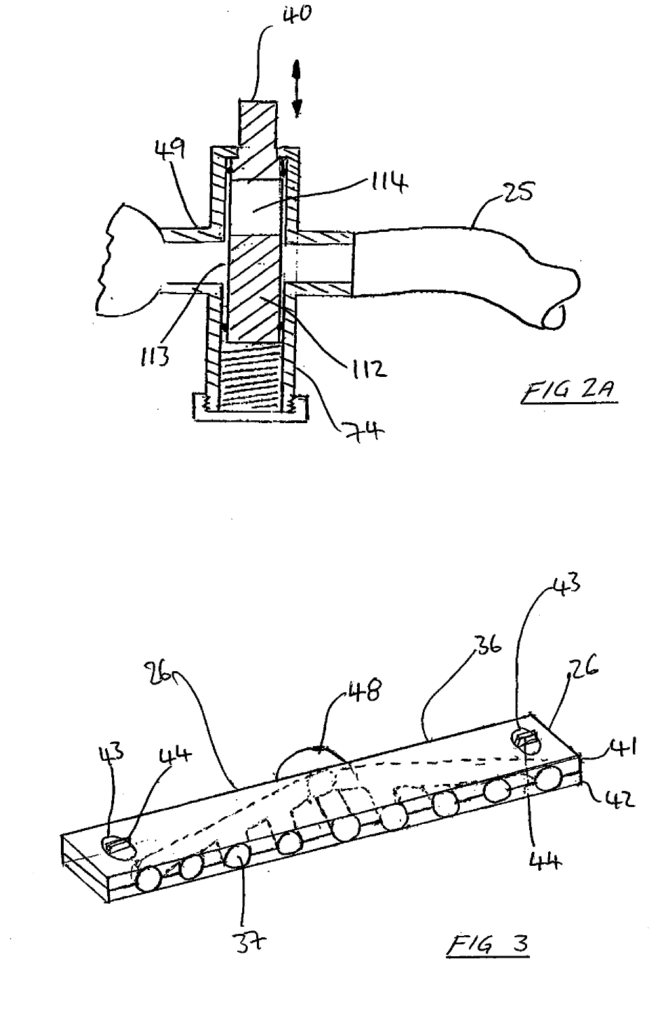

FIG. 2 is a diagrammatic view of an applicator as used in the first embodiment and incorporating a swivel fitting;

FIG. 2A is a schematic view of a mechanical valve incorporated in an applicator;

FIG. 3 is a diagrammatic view showing the construction of a handheld applicator having multiple outlets;

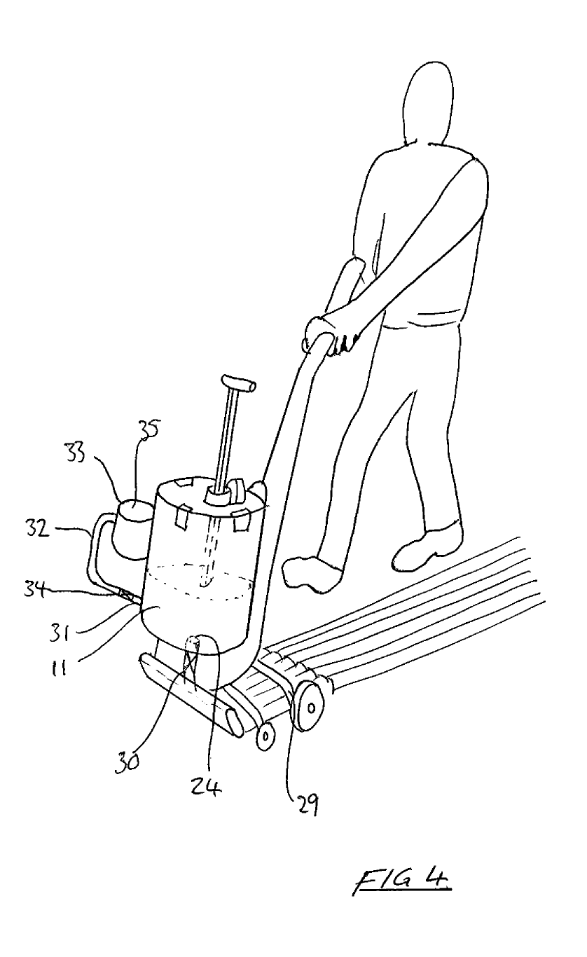

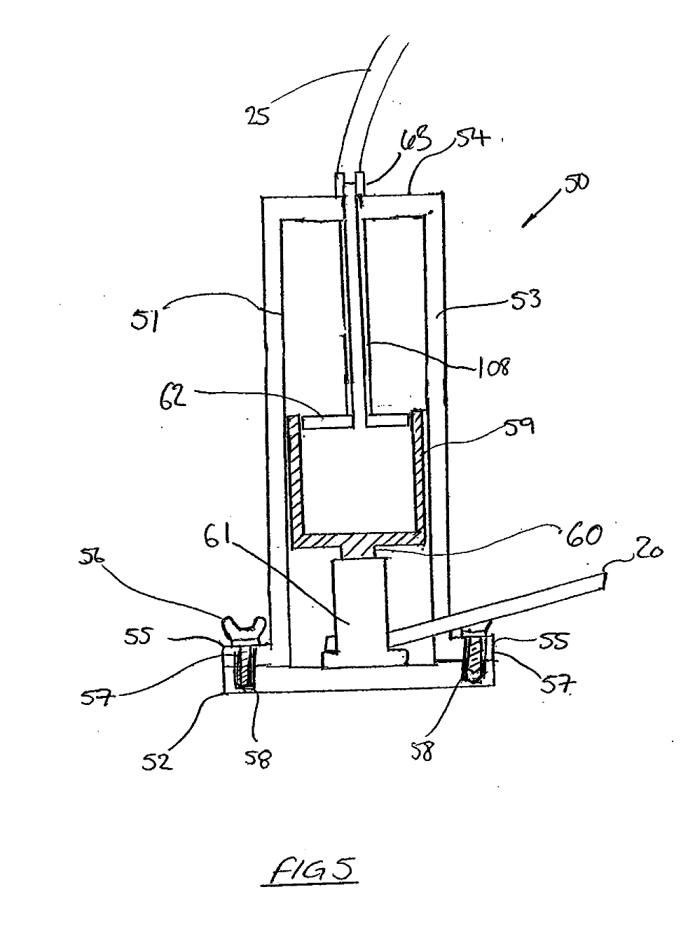

FIG. 4 is an illustration of the first embodiment mounted on a trolley;

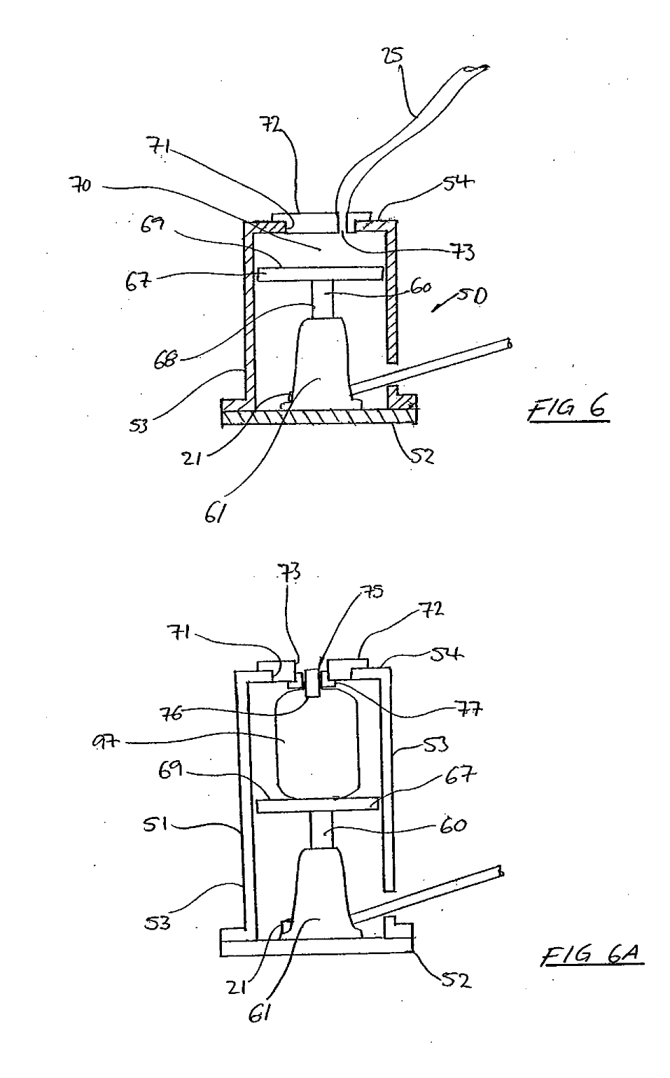

FIG. 5 is a schematic view of the second embodiment of the invention and incorporating a conventional bottle jack;

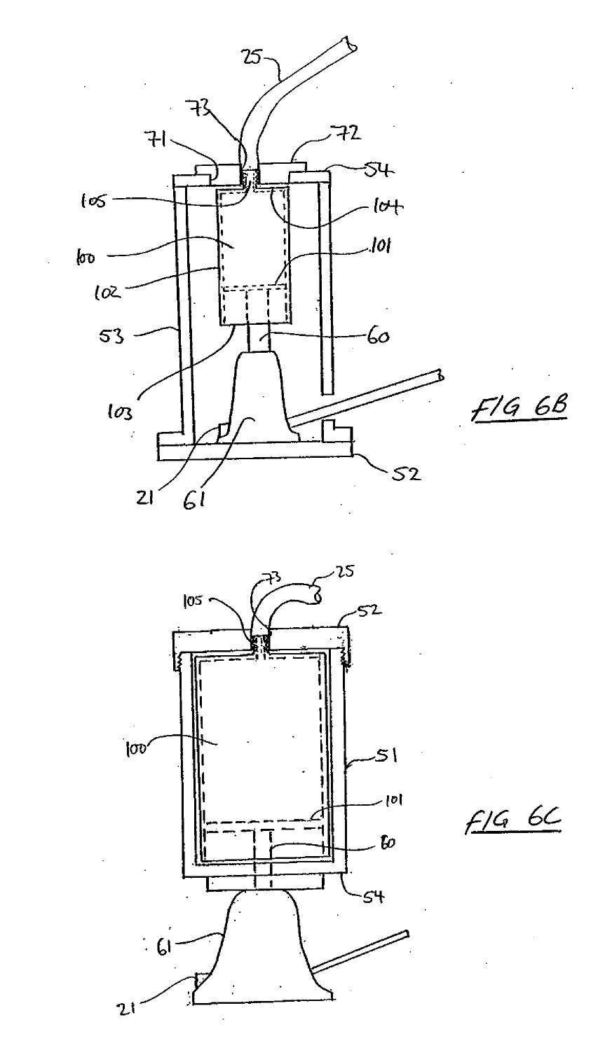

FIG. 6 is a schematic view of the third embodiment of the invention which also incorporates a conventional bottle jack;

FIG. 6A is a schematic view of the third embodiment of the invention using a flexible pack of adhesive;

FIG. 6B is a schematic view of the third embodiment using an adhesive cartridge;

FIG. 6C is a schematic view of the third embodiment having an alternative arrangement for using an adhesive cartridge;

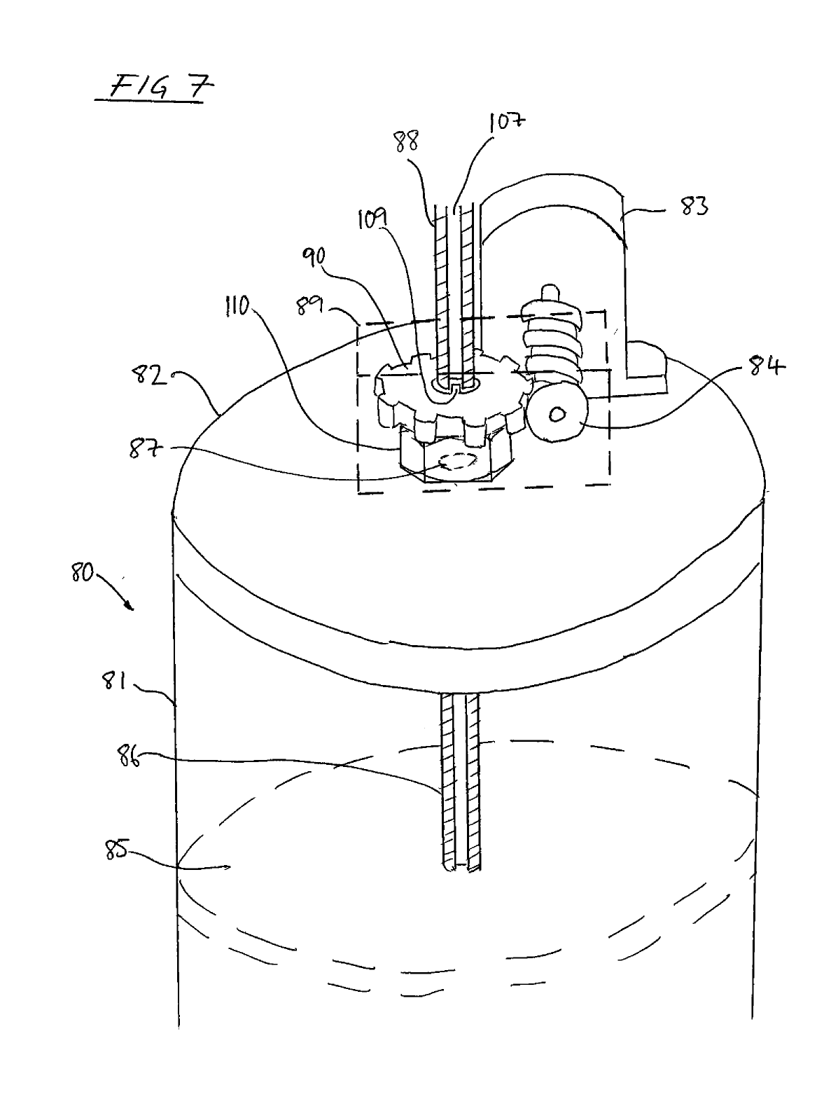

FIG. 7 is an isometric view of the fourth embodiment of the invention which incorporates a lead screw and nut;

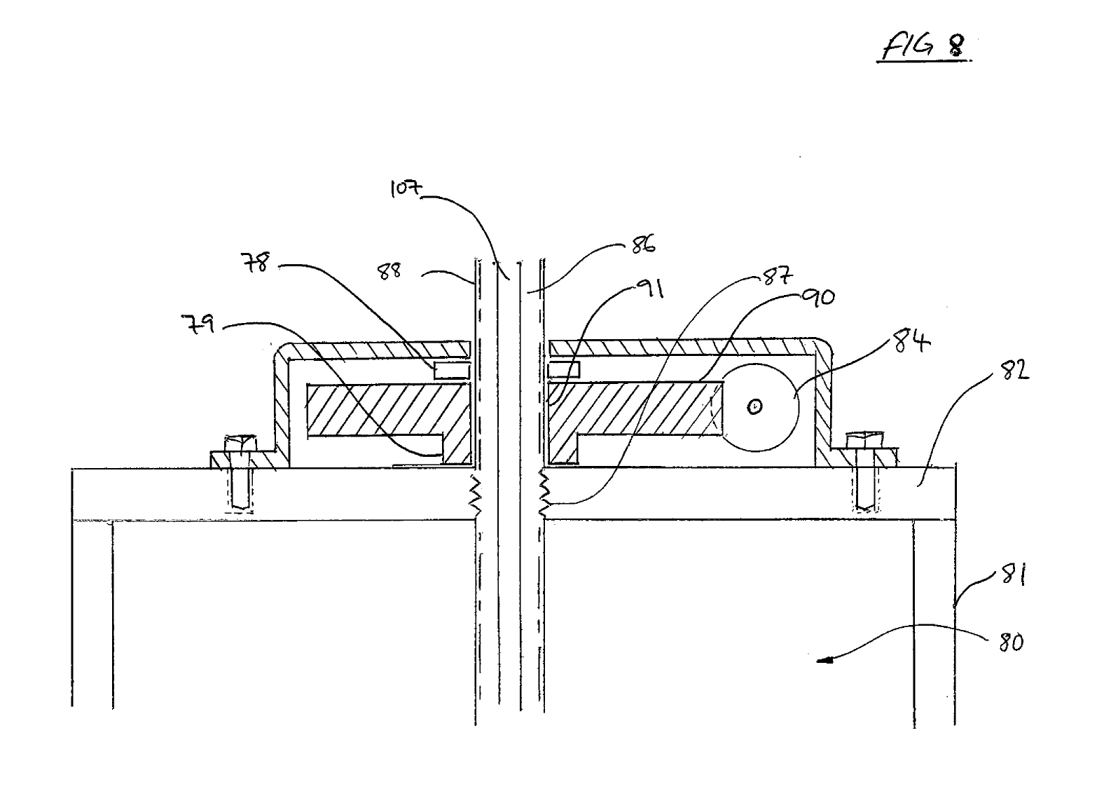

FIG. 8 is a cross-section through the fourth embodiment of FIG. 7; and

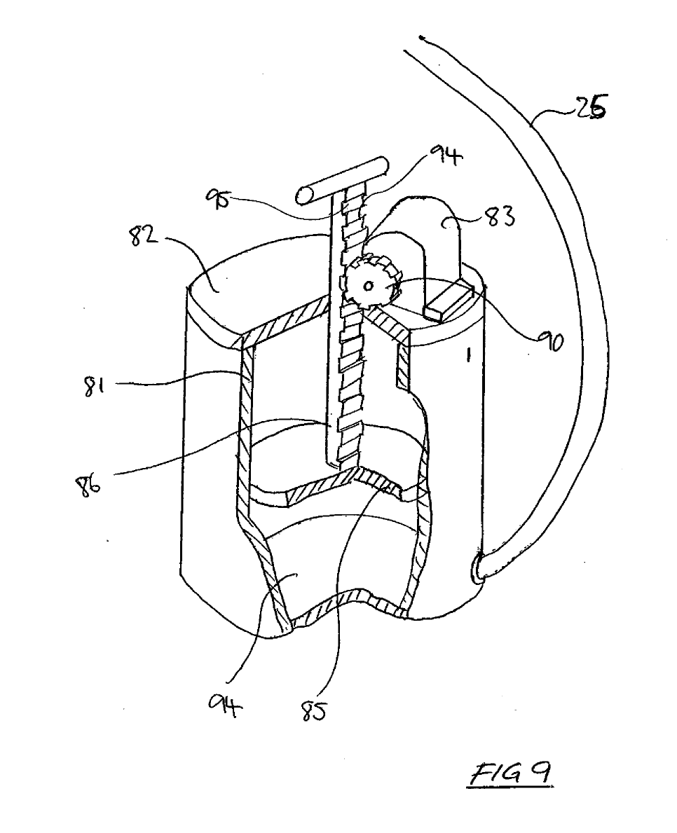

FIG. 9 is a diagrammatic view of the fifth embodiment of the invention and incorporating a rack and pinion arrangement.

Referring initially to FIG. 1, the tiling adhesive application apparatus, generally indicated 10, includes a cylindrical container 11 for adhesive and having a circular base 12 and a circumferential side wall 13 defining an upper opening. A circular lid 14 is fitted over the upper opening and is secured in place by clips 15 engaging hooks 16 provided on the sidewall 13 adjacent the opening.

An inverted bottle jack 17 is mounted on the lid 14 of the container 11 and comprises a cylinder 19, a ram-rod 18, a pump lever 20 and a pressure release valve 21. The inverted bottle jack further includes a base plate 22 secured to the lid 14. The ram-rod 18 of the bottle jack extends through an aperture (not shown) formed in the lid and has a piston 23 secured to its free end. The piston is circular and is a sliding fit within the container, seals being provided around the piston to minimise leakage past the piston.

The base 12 of the container is provided with an outlet 24 through which tile adhesive is expelled on movement of the piston 23 towards the base 12. The outlet includes a boss to which one end of a flexible hose 25 is secured by a worm-drive hose clip 27, the other end of the hose being secured to a handheld multi-nozzle applicator 26. Though the outlet 24 is shown as a simple boss, it could comprise a more sophisticated fitting such as a screw connector or snap fit assembly.

A harness 28 is connected to the container 11 so that the tiling adhesive application apparatus 10 can be conveniently carried on an operator's back with the pump lever 20 extending forwardly. This arrangement enables the operator to pressurise adhesive in the container 11 by operating the jack lever 20, while applying adhesive to a surface to be tiled, with applicator 26.

Referring now to FIGS. 2, 2a and 3, the hose 25 is connected to the handheld applicator 26 by a swivel fitting 45, so as to enable the operator to adjust the angular position of the applicator 26. The swivel fitting 45 comprises two parts 46 rotatably coupled to one another and each having a respective tube 47,48 extending therefrom and in fluid communication with one another through the fitting. One tube 47 is connected to a sleeve 49, which is gripped by the operator and in which an end portion of the hose 25 is connected; and the other tube 48 is connected to a nozzle assembly of the applicator 26. A mechanical valve 74 is provided in the sleeve 49, and which includes a trigger 40 operable to enable adhesive to pass therethrough. The sleeve 49 defines a transverse bore 113 in which a spring-loaded spool 112 is slidably mounted, the trigger 40 comprising a projection from that spool 112 projecting out of the sleeve. An aperture 114 is formed diametrically through the spool 112 and in the normal position of the spool, communication through the valve is closed. Depressing the trigger 40 moves the spool so that the aperture 114 comes into alignment with the axis of the sleeve 49, and thus adhesive may pass through the valve.

Referring to FIG. 3, the body is formed from two complementary parts 41,42 which can be disassembled for the purpose of cleaning. One or more channels are formed in the internal face of each part and extend from the tube 48 to at least one outlet opening 37. The parts 41,42 are generally symmetrical such that when they are fitted together, the channels form ducts through which the adhesive flows. The two parts are held together with two thumbscrews 44 to facilitate disassembly for cleaning.

In use, the lid 14 of the apparatus is removed and the container 11 is filled with the required amount of adhesive. Before refitting the lid 14, it might be necessary to retract the ram-rod 18 by loosening the pressure release valve 21 and pushing the ram-rod back into the cylinder 19. Once the lid 14 is refitted and the pressure release valve 21 is tightened, the tiling adhesive application apparatus 10 is ready to be used. In so doing, the operator lifts and lowers the pump lever 20 so as to extend the ram and consequently pressurise the adhesive in the container, thereby causing adhesive to flow through the hose 25 and out of the outlets 37, so long as the mechanical shut-off valve located on the handheld applicator is open.

FIG. 4 shows an alternative arrangement of the tiling adhesive application apparatus 10 wherein the container 11 is mounted on a trolley 29 for applying tile adhesive to flooring. In this instance, no hose is required since the outlet 24 from the container connects directly to applicator 30.

A pipe 32 interconnects a second outlet 31 provided on the container with an overflow vessel 33 attached to the outside of the container 11. A pressure relief valve 34 is located in the pipe or in the second outlet 31 such that adhesive is permitted to pass therethrough only when the pressure in the container 11 reaches a predetermined value. This feature is particularly useful if the applicator 30 or handheld applicator 26 becomes blocked without the operator noticing, which could result in excessive pressure being generated in the container. In the absence of this feature, the container could be damaged if too much pressure is generated. The overflow vessel can be emptied by removing cover 35.

Though the first embodiment of the invention includes a lid located at the upper end of the container and which is removable to permit filling of the container with adhesive, it will be understood that the container may have a fixed lid and a removable base for filling the container with adhesive, or may have both a removable base and a removable lid.

The second embodiment 50 is shown in FIG. 5. This has a container 51 mounted on a removable lid 52. The container 51 comprises a circumferential wall 53 depending from a circular end wall 54. The lower edge of the wall 53 is provided with a flange 55 extending outwardly therefrom and which mounts the periphery of the lid 52. The container is secured to the lid 52 by bolts 56 extending through holes 57 formed in the flange 55 and engaging threaded holes 58 formed in the lid. The heads of the bolts 56 are suitably profiled to permit tightening by hand, thus obviating the need for tools.

A circular chamber 59 for holding adhesive is mounted on ram-rod 60 extending upwardly from a conventional bottle jack 61 fastened to the lid 52. A pressure member 108 depends from the end wall 54 of the container 51 and comprises a hollow rod having a circular plate 62 at its lower end, the plate being a close sliding fit in chamber 59. An outlet 63 is provided on the end wall 54, in communication with the hollow rod 108 and which is connected to the flexible hose 25. The bottle jack 61 has a pump lever 20 and pressure release valve 65 the pump lever being accessible from outside the container 51. As the bottle jack 61 is pumped by lever 20, the chamber 59 is lifted so that the pressure member 62 moves further inside the chamber 59, thereby pressurising the adhesive therein and forcing it through the outlet 63 towards the hose 25.

To lower the chamber 59 to permit the filling thereof with adhesive, it is necessary to remove the container 53 from the lid 52. This is carried out by removing bolts 56 and lifting the container upwardly so that the sidewalls come clear of the chamber 59.

The hose 25 is connected to the applicator 26 in much the same way as described in the previous embodiment. Likewise, the container 51 can be mounted on a trolley 29 or can be supported by a harness 28.

FIG. 6 shows an example of a third embodiment of the tiling adhesive application apparatus. The container generally indicated 50 is substantially cylindrical and comprises a circular upper end wall 54 and a circumferential sidewall 53 depending downwardly therefrom and arranged to mount a detachable lid 52. A bottle jack 61 is mounted on the lid 52 and has a ram-rod 60 extending upwardly therefrom in the form of a plunger 68. A piston 67 provided on the end of the plunger 68 has an upper surface 69 which, in combination with the sidewall 53 of the container, defines a chamber 70 for holding adhesive. An opening 71 is formed in the upper portion 54 of the container 51 to permit filling of the chamber 70 with adhesive. The opening 71 is provided with a detachable filler cap 72 having an outlet 73 to which is connected a hose 25.

The container 51 is filled with adhesive by removing the filler cap 72 and pouring the adhesive in through the opening 71. To lower the piston 67, the operator must loosen a pressure release valve integrally provided on the bottle jack, and then push the ram-rod towards the cylinder. The pressure release valve can be accessed by removing the container 51 from the lid 52, or an aperture may be provided in the side wall 53 to give access to the valve.

FIG. 6A shows an example of the third embodiment of tiling adhesive application apparatus 50 wherein a flexible pack 97 containing tiling adhesive is positioned on the upper surface of the piston 69. In this case no seals need be provided between the piston 67 and the sidewalls 53 of the container 51. The flexible pack 97 comprises a tubular skin which has been pre-filled with tiling adhesive and closed at each of its ends to form a sealed unit. One of the two ends is shaped to define a neck portion, which must be opened before being fitted to a connector 75. The connector 75 has a circular spigot 76 which is to be inserted into the open neck of the pack 97, and a collar 77 which is to be mounted around the neck so at to secure it to the spigot 76. The flexible pack 97 and connector 75 can then be installed in the container 51 and arranged so that the axis of the flexible pack 97 extends vertically and the connector 75 locates in an outlet 73 defined in the filler cap 72 as it is screwed into an opening 71 formed in the end wall 54.

Alternatively, the flexible pack 97 could be sized to form a close fit with the walls 53 of container 51, and in which case connector 75 may not be required. The flexible pack 97 is inserted in to the container 51 and the neck portion is then cut open before fitting the filler cap 72. When the bottle jack 61 is pumped and the ram-rod 60 rises, piston 67 bears against the bottom end of the flexible pack 97, thereby expelling adhesive through the opening cut in the neck thereof. Since the flexible pack 97 forms a close fit with the inside of the container, the adhesive is compelled to flow through the outlet 73 and not leak between the walls 53 and the pack 97, to the piston 67.

As well as using the tiling adhesive application apparatus for dispensing adhesive poured into the container or in a flexible pack held in the container, the invention can also be used for dispensing adhesive contained in a cartridge. FIG. 6B shows a cartridge 100 containing adhesive and comprising a tubular body 102 having an open rear end 103 and a closed front end 104 in the form of an integral end cap. Adhesive contained in the cartridge is sealed in a chamber defined by the tubular body 102, the end cap 104 and a circular piston 101 which has a sliding fit within the tubular body. A nozzle 105 extends axially from the closed front end 104 and has a thread formed around its outer surface that engages a threaded bore 73 formed in an end cap 72 fitted in the end wall 54. The nozzle is provided with a nipple which must be cut off before installing the cartridge.

In use the cartridge 100 is positioned inside the container 51 with its axis extending vertically and so the ram-rod 60 engages the piston 101. As the bottle jack 61 is pumped, the ram-rod 60 forces the piston 101 along the cartridge 100 thereby expelling adhesive through the nozzle 105.

FIG. 6C shows a further arrangement of the tiling adhesive application apparatus for holding the adhesive cartridge 100 described above. There is provided a cylindrical container 51 having its axis extending vertically and having a closed lower end in the form of an integral end cap 54 and an open upper end on which is fitted a lid 52. A conventional bottle jack 61 is mounted externally of the integral end cap 54 and has a ram-rod 60 extending through an opening formed in the end cap 54, into the container. The threaded nozzle 105 of the cartridge 100 is screwed into a threaded bore 73 formed concentrically in the lid 52, which lid is then fitted over the open end of the container 51, so that the ram-rod 60 locates inside the cartridge 100 and bears against the piston 101. A hose 25 is attached to the lid in fluid communication with the bore 73 formed in the lid 52, in the manner described in previous embodiments. With the bottle jack mounted outside the container, it is easier to access pressure release valve 21, to enable retraction of the ram-rod 60 and permit a new cartridge to be fitted.

It should be noted that the bottle jack 61 featured in embodiments 1 to 3 above could be replaced by a single or double acting hydraulic ram driven by a hydraulic pump or by a single or double acting pneumatic ram driven by a suitable source of compressed air together with a control arrangement therefor must be provided.

The fourth embodiment of the invention is illustrated in FIGS. 7 and 8. There is provided a cylindrical container 80 generally comprising a circular base (not shown) and a circumferential wall 81 extending upwardly therefrom. The container is provided with a lid 82 on which is mounted an electric motor 83 arranged to drive a worm 84. A piston 85 is provided in the container 80 and has a plunger 86 extending upwardly therefrom. A lead screw 88 formed on the plunger 86 engages either a threaded bore 87 formed in the lid (see FIG. 8) or extends through a clearance bore in the lid and engages a nut 110 welded to the upper surface of the lid 82 (see FIG. 7). The lead screw then extends through a clearance bore 91 formed concentrically in a gear 90 coupled to the worm 84. A key 109 extends radially inwardly from the periphery of the clearance bore 91 and which locates in a keyway slot 107 formed along the length of the lead screw 88, thereby rotatably coupling the lead screw 88 to the gear 90. The gear 90 and worm 84 are housed in a casing 89 bolted to the lid which serves to constrain the gear 90 vertically while also shielding the moving parts. The underside of the gear 90 has a thrust boss 79 extending therefrom and which bears against the nut 110 (FIG. 7) or the lid 82 (FIG. 8). A washer 78 is provided between the upper surface of the gear 90 and the casing 89.

A handle (not shown) is connected to the upper end of the plunger by an arm extending perpendicular therefrom. The handle can be manually rotated about the axis of the plunger so as to cause the piston to rise or fall, depending on the direction of rotation.

A handheld applicator is provided with a trigger for operating the motor, a speed controller for varying the rotational speed of the motor and a direction controller for controlling the direction in which the motor and worm rotate. When the trigger is activated the motor drives the worm and gear, and which consequently causes the plunger to either rise or fall depending on the setting of the direction controller. The handheld applicator could include a mechanical shut of valve and a pressure gauge. A hose connects the handheld applicator to an outlet formed in the base of the container 80.

In addition, the tiling adhesive application apparatus of the fourth embodiment may be provided with a safety device (not shown). Such a safety device should be arranged to cut the supply of electrical power to the motor in the event of an overload condition, caused for example in the event of a blockage between the outlet of the container and the outlets 37 of the handheld applicator. Such a safety device may comprise a comparator circuit in which the current drawn from the power supply is compared to a predetermined value and once that value is exceeded the power supply is disconnected from the motor.

Before using the tiling adhesive application apparatus, the operator should ensure that there is sufficient tiling adhesive in the container. The container can be filled with tiling adhesive by removing the lid and pouring adhesive through the opening. The lid should then be fitted correctly and the motor should be set to rotate in the required direction by adjusting the motor controller. The operator simply presses the trigger to dispense adhesive, which powers the motor, thereby causing the gear and nut to rotate in unison.

In an alternative arrangement (not shown), the lead screw extends upwardly through a clearance bore formed in the lid of the container and has a keyway formed along its length which co-operates with a key extending inwardly from the periphery of the bore in the lid. The lead screw engages a threaded bore formed concentrically in a gear housed in a casing and coupled to a motor. Thus, the lead screw is restrained against rotational movement relative to the lid and the gear is restrained against vertical movement relative to the lid. Operation of the motor causes the gear to rotate about the lead screw, thereby causing the lead screw to rise or fall depending upon the direction of rotation.

The fifth embodiment of the present invention will now be described with reference to FIG. 9. The tiling adhesive application apparatus has a container 80 comprising a circular base 94 and a circumferential wall 81 extending upwardly therefrom. The container is provided with a lid 82 on which an electric motor 83 with an integral reduction gearbox is mounted. A piston 85 provided in the container has a plunger 86 extending upwardly therefrom and through an aperture formed in the lid. The plunger has a generally rectangular cross section and a toothed rack 94 formed in one of its four sides which engages a gear 90 coupled to the motor 83. In use, rotation of the motor in either direction causes the plunger either to rise or fall.

The fifth embodiment of the invention is operated in the same way as the fourth embodiment of the invention, the only difference being the way in which rotational movement generated by the motor is transformed into linear movement of the plunger for driving the piston.

Alternatively, the motor 83 could be replaced by a mechanism including a rotatable handle (not shown) coupled to gear 90, whereby rotation of the handle causes the rack 94 to rise or fall depending on the direction of rotation.

1. Apparatus for applying adhesive to a surface to be tiled and having a container for the adhesive, an applicator having at least one outlet opening for adhesive and a duct interconnecting the applicator with an adhesive outlet port provided on the container, wherein the container is of generally tubular form having opposed end walls at least one of which is in the form of a removable lid for the container, a plunger supported on one of the end walls for movement into the container so as to expel adhesive from the container, and a drive arrangement operable to cause relative movement of the plunger with respect to the end wall supporting the plunger thereby to expel adhesive from the container through the duct to the applicator.

2. Apparatus according to claim 1, wherein the drive arrangement includes a ram having a cylinder and a ram-rod projecting therefrom which rod serves as said plunger.

3. Apparatus according to claim 2, wherein the ram cylinder is mounted on one of the end walls externally of the container and the ram-rod extends through an opening in that end wall, into the container.

4. Apparatus according to claim 2, wherein the ram cylinder is mounted on one of the end walls internally of the container.

5. Apparatus according to claim 2, wherein the ram cylinder is mounted on the removable lid of the container.

6. Apparatus according to claim 2, wherein a chamber for adhesive is disposed within the container and is mounted on the ram-rod, and a pressure member projects into the container from the opposed end wall from that mounting the ram cylinder which pressure member is slidably received in the chamber and defines the outlet port of the container, whereby movement of the chamber with respect to the pressure member on operation of the ram expels adhesive from the chamber and so out of the container.

7. Apparatus according to claim 2, wherein the ram comprises an hydraulic ram and the apparatus further comprises a reservoir for hydraulic fluid together with a pump for causing expansion of the ram.

8. Apparatus according to claim 7, wherein there is an electric motor drivingly coupled to said pump, and means for controlling operation of the pump thereby to permit adjustment of the axial position of the ram-rod.

9. Apparatus according to claim 7, wherein the hydraulic ram has an integral reservoir for hydraulic fluid and the pump includes a manually-operable pump lever and a pressure release valve.

10. Apparatus according to claim 9, wherein the hydraulic ram is in the form of a bottle jack.

11. Apparatus according to claim 2, wherein the ram comprises a pneumatic ram together with a source of air under pressure and a control arrangement therefor.

12. Apparatus according to claim 2, wherein the ram is a double-acting ram and has a control arrangement arranged to permit driving of the ram-rod in either direction with respect to the ram cylinder.

13. Apparatus according to claim 1, wherein the drive arrangement comprises a pinion mounted on the end wall of the container supporting the plunger and having its axis extending transversely to the axis of the plunger, and a toothed rack is formed on the plunger which rack is engaged by the pinion whereby rotation of the pinion moves the plunger relative to said end wall.

14. Apparatus according to claim 13, wherein the drive arrangement includes one of an electric motor and a control arrangement therefor, and a manually-operable mechanism to effect rotation of said pinion.

15. Apparatus according to claim 1, wherein at least a part of the plunger is screw-threaded and is engaged with threads associated with the end wall supporting the plunger, and the drive arrangement includes means to effect rotation of the plunger thereby threading the plunger into or out of the container.

16. Apparatus according to claim 15, wherein the end wall supporting the plunger has a screw-threaded bore formed therethrough and the screw-threaded part of the plunger is engaged therewith.

17. Apparatus according to claim 15, wherein the end wall supporting the plunger has a plain bore formed therethrough and the screw-threaded part of the plunger is engaged with the nut.

18. Apparatus according to claim 15, wherein the drive arrangement includes a rotation member mounted on the plunger for sliding movement therealong but restrained against rotation with respect thereto, and an electric motor is mounted on the end wall supporting the plunger and is arranged to turn the rotation member.

19. Apparatus according to claim 18, wherein the plunger has a keyway formed along the length thereof and the rotation member is in the form of a gear wheel keyed to the plunger.

20. Apparatus according to claim 1, wherein at least a part of the plunger is screw-threaded and is engaged with threads in a rotation member rotatably mounted on the end wall supporting the plunger, and the drive arrangement includes means to effect rotation of said member thereby threading the plunger into or out of the container.

21. Apparatus according to claim 18, wherein the rotation member comprises a gear wheel and the motor drives a worm gear drivingly coupled to said gear wheel.

22. Apparatus according to claim 14, wherein the electric motor includes a reduction gear box having an output shaft coupled indirectly to the plunger.

23. Apparatus according to claim 13, wherein a handle is provided on the plunger to enable the apparatus to be operated manually.

24. Apparatus according to claim 1, wherein the container has a cylindrical portion for receiving adhesive and the plunger supports a piston which is a sliding fit in said cylindrical portion, whereby adhesive contained in the cylindrical portion is expelled on movement of the piston further into the cylindrical portion.

25. Apparatus as claimed in claim 17, wherein the container is arranged to receive a flexible carrier of adhesive and which when opened communicates with the outlet port whereby compression of the carrier on movement of the plunger into the container drives adhesive out of the container.

26. Apparatus as claimed in claim 25, wherein the container is provided with an internal connector in communication with the outlet port and for receiving an open end of the adhesive carrier in an adhesive-tight manner.

27. Apparatus according to claim 1, wherein the container includes a connector for a substantially rigid tube of adhesive having an integral piston, the connector being arranged to support a tube along the axis of the container so that the plunger may engage the piston of a supported tube and expel adhesive therefrom.

28. Apparatus according to claim 1, wherein the container has a further outlet in fluid communication with a catch tank, a pressure valve being provided between the container and the catch tank whereby adhesive may pass into the catch tank only when the pressure in the container reaches a predetermined value.

29. Apparatus according to claim 1, wherein the container is mounted on wheels or tracks.

30. Apparatus according to claim 1, wherein the applicator comprises a body defining a plurality of outlet nozzles coupled internally of the applicator to a single inlet in communication with the duct from the container connected thereto.

31. Apparatus according to claim 1, wherein the applicator is formed from two or more parts with passageways for adhesive defined therebetween, the parts being separable for cleaning purposes.

32. Apparatus according to claim 1, wherein the applicator includes a swivel fitting which permits the orientation of the applicator to be adjusted.

33. Apparatus according to claim 1, wherein said duct comprises a flexible hose interconnecting the container and the applicator.

34. Apparatus according to claim 1, wherein the applicator includes a control valve whereby the outflow of adhesive from the applicator may be controlled.

35. Apparatus according to claim 1 and in which the drive arrangement includes an electric motor, wherein the applicator has an electrical control connected to the drive arrangement thereby to permit control of the expulsion of adhesive from the container.

36. Apparatus according to claim 35, wherein said electrical control comprises at least one of a flow rate control switch, a plunger direction control switch and a pressure control.

37. Apparatus according to claim 35, wherein the electrical control includes an overload cut out device to inhibit operation of the motor in the event that the power draw thereof exceeds a predetermined value.
